(19) United States
(12) Patent Application Publication
(10) Pub. No.: US 2022/0093379 A1
(43) Pub. Date: Mar. 24, 2022

(54) MATRIX FILM DEPOSITION SYSTEM AND MATRIX FILM DEPOSITION METHOD

(71) Applicant: SHIMADZU CORPORATION, Kyoto-shi, Kyoto (JP)

(72) Inventors: Kenta TERASHIMA, Kyoto-shi, Kyoto (JP); Koretsugu OGATA, Kyoto-shi, Kyoto (JP)

(73) Assignee: SHIMADZU CORPORATION, Kyoto-shi, Kyoto (JP)

(21) Appl. No.: 17/422,482

(22) PCT Filed: Mar. 1, 2019
(86) PCT No.: PCT/JP2019/008104

§ 371 Date: Jul. 13, 2021

(51) Int. Cl. H01J 49/04; H01J 49/16; B05B 12/14

(52) U.S. Cl. CPC H01J 49/045; B05B 12/1427; H01J 49/0418; H01J 49/164

(57) ABSTRACT

In a system for depositing a matrix film by nebulizing a matrix solution to a sample plate on which a sample is placed, a chamber is filled with a dry gas by supplying the dry gas into the chamber in a state where the sample plate is housed in the chamber (step S12), thereafter, the supply of the dry gas to the chamber is stopped (step S14), and in this state, a solution containing a matrix substance used for a matrix-assisted laser desorption/ionization method is nebulized toward the sample plate (step S15). As a result, it is possible to enhance the extraction efficiency of the measurement target component in the sample into the matrix solution while suppressing the size of the crystal particles formed on the sample plate, and it is possible to stably achieve high spatial resolution and high detection sensitivity in mass spectrometry imaging.

### TECHNICAL FIELD

The present invention relates to a matrix film deposition system and a matrix film deposition method for depositing a film of a matrix substance on a sample plate used for performing mass spectrometry imaging using a matrix assisted laser desorption/ionization (MALDI) method.

### BACKGROUND ART

The MALDI method is an ionization technique suitable for an analysis of a sample which absorbs little laser light or a sample which is easily damaged by laser light (such as proteins). In this technique, a matrix substance which easily absorbs laser light and which is easily ionized is previously mixed in a sample to be measured and the obtained mixture is irradiated with laser light to ionize the sample. In general, the matrix substance is added to the sample as a solution, and the measurement target substance contained in the sample is included into the solution of the matrix substance (matrix solution). Subsequently, it is dried and the solvent in the solution vaporizes to form crystal particles of the matrix substance containing the measurement target substance. Then, those particles are irradiated with laser light, whereby the measurement target substance is ionized due to interaction among the measurement target substance, matrix substance, and laser light. The MALDI method has been widely used in the areas of bioscience and others since it enables an analysis of polymer compounds having high molecular weights without significantly dissociating them, and furthermore, since it also has a high sensitivity and is suitable for microanalysis.

In recent years, a mass spectrometry imaging method for directly visualizing a two-dimensional distribution of biomolecules, metabolites, or the like on a slice of biological tissue using a MALDI mass spectrometer has been attracting attention. In the mass spectrometry imaging method, a two-dimensional image representing the intensity distribution of ions having a specific mass-to-charge ratio can be obtained on a sample such as a slice of biological tissue. Therefore, for example, by checking the distribution of substances specific to pathological tissues such as cancer, various applications in the medical, drug discovery, and life science fields, such as grasping the spread of disease and confirming the therapeutic effects of medication, etc. are expected.

General methods for preparing a sample, i.e., adding a matrix substance to a sample in the mass spectrometric imaging method include a method (hereinafter referred to as spray method) of spraying and applying the matrix solution onto a plate where the sample such as a slice of biological tissue is put (see Patent Literature 1, for example). FIG. 8 shows a schematic configuration of a matrix film deposition system for preparing a sample by a spray method. This matrix film deposition system includes a chamber 80 in which a sample stage 81 to which a sample plate P is attached is housed, and a nebulizing nozzle 70 for spraying a matrix substance onto the sample plate P. The nebulizing nozzle 70 includes a gas pipe 72 through which the nebulizing gas flows, and a solution pipe 71 through which the matrix solution flows. These have a double pipe structure in which the solution pipe 71 is inserted inside the gas pipe 72, and the tip of the solution pipe 71 is surrounded by the tip of the gas pipe 72. Further, a needle 73 is inserted into the center of the solution pipe 71, and the tip of the needle 73 slightly projects from the tip of the solution pipe 71. The inside of the solution pipe 71 is filled with a matrix solution, and its proximal end is inserted into a solution container 75 containing the matrix solution. The proximal end of the gas pipe 72 is connected to a gas source 74 such as a gas cylinder. Note that, during nebulizing, the chamber 80 is not sealed but open to the atmosphere in order to release gas ejected into the chamber 80 from the tip of the gas pipe 72 to the outside.

Since the tip of the solution pipe 71 is surrounded by the tip of the gas pipe 72 as described above, when the high-pressure nebulizing gas supplied from the gas source 74 is ejected from the tip of the gas pipe 72, the vicinity of the tip of the solution pipe 71 is depressurized (Venturi effect), and the matrix solution is drawn out from the tip. The matrix solution drawn out from the tip of the solution pipe 71 is sheared by the nebulizing gas into fine droplets, and the fine droplets are ejected from the nozzle 70 along with the flow of the nebulizing gas. At this time, the matrix solution flows on the needle 73 so as to improve the shearing efficiency of the matrix solution by the nebulizing gas, making the droplets further smaller. The matrix solution injected from the nebulizing nozzle 70 as described above falls over the sample plate P on the sample stage 81 facing the nebulizing nozzle 70.

When the matrix solution nebulized as described above falls on the sample plate P to which a sample such as a slice of biological tissue is attached, components (sample components) contained in the sample are diffused into the matrix solution, and then crystal particles containing the sample components and the matrix substances are formed on the sample plate P through vaporization of the solvent in the matrix solution containing the sample components.

### CITATION LIST

### Patent Literature

Patent Literature 1: JP 2016-114400 A ([0004])

### SUMMARY OF INVENTION

### Technical Problem

In order to obtain a mass spectrometry image accurately representing the distribution of a target substance in the mass spectrometry imaging method, it is necessary to detect the target substance with high spatial resolution and high sensitivity. One of the major factors for determining the spatial resolution in mass spectrometry imaging using MALDI is a particle size (size of crystal particles) of the matrix substance in the prepared sample, and the smaller the particle size is, the higher spatial resolution is obtained. In addition, one of the major factors for determining the detection sensitivity in the mass spectrometry imaging method is the extraction efficiency of the measurement target substance in the sample into the matrix solution, and the higher the extraction efficiency, the higher the sensitivity.

However, the above-described spray method has a problem that the size of the crystal particles formed on the sample plate and the detection sensitivity of the measurement target substance are not stable.

The present invention has been made to solve the above problems, and an object of the present invention is to provide a matrix film deposition system and a matrix film deposition method for MALDI capable of stably realizing high spatial resolution and high detection sensitivity when mass spectrometry imaging method is performed.

### Solution to Problem

The present inventors have conducted intensive studies to solve the above-mentioned problems, and found that the humidity in the chamber at the time of nebulizing the matrix solution has an effect on the size and shape of the crystal particles formed on the sample plate, and the extraction efficiency of the measurement target substance in the sample. Thus the present invention is achieved.

According to the present invention made to solve the above problems, a matrix film deposition system includes:

a chamber configured to house a sample stage on which a sample plate is placed;

a nebulizer arranged to nebulize a solution containing a matrix substance used for a matrix-assisted laser desorption/ionization method toward the sample stage;

a gas inlet formed in the chamber;

a dry gas supplier arranged to supply a dry gas through the gas inlet; and

a controller configured to control the dry gas supplier and the nebulizer to supply the dry gas through the gas inlet to fill the chamber with the dry gas, and then to nebulize the solution containing the matrix substance in a state where supply of the dry gas through the gas inlet is stopped or reduced.

Here, the dry gas is a low-humidity gas, and is preferably a gas having a humidity of 30% or less, and more preferably 15% or less. Further, “to nebulize the solution containing the matrix substance in a state where supply of the dry gas through the gas inlet is stopped or reduced” is not necessarily limited to a case where the nebulizing is started after the supply of the dry gas through the gas inlet is stopped or reduced, but also includes a case where the nebulizing is started first, and then the supply of the gas through the gas inlet is stopped or reduced slightly later.

According to the matrix film deposition system of the present invention having the above configuration, since the solution (matrix solution) containing the matrix substance is nebulized after the air in the chamber is filled with the dry gas, the size of the crystal particles formed on the sample plate is not affected by the humidity of the outside air as in the conventional case, and mass spectrometry imaging can be always performed with stable spatial resolution. In addition, the size of the crystal particles formed on the sample plate can be suppressed, and high spatial resolution can be achieved, as compared with the related art. Furthermore, in the matrix film deposition system according to the present embodiment, after the inside of the chamber is filled with the dry gas, the matrix solution is nebulized in a state where the supply of the dry gas is stopped, and thus the humidity in the chamber increases with the progress of nebulizing. As a result, as compared with a case where nebulizing is performed while the supply of the dry gas to the chamber is continued, the extraction efficiency of the sample component by the matrix solution can be enhanced, and the detection sensitivity of the measurement target substance in mass spectrometry imaging can be enhanced. In the present invention, when the matrix solution is nebulized in a state where the supply of the dry gas is reduced (without completely stopping the supply of the dry gas), the flow rate of the dry gas during nebulizing of the matrix solution is set so that the humidity in the chamber increases with the progress of nebulizing of the matrix solution. Such a flow rate of the dry gas can be experimentally determined in advance, for example.

In the matrix film deposition system according to the present invention, the controller further controls the dry gas supplier and the nebulizer so as to stop nebulizing of the solution containing the matrix substance by the nebulizer, fill the chamber with the dry gas by supplying the dry gas through the gas inlet again, and then perform nebulizing of the solution containing the matrix substance by the nebulizer again while continuing supply of the dry gas through the gas inlet.

In the matrix film deposition system of the present invention having the above configuration, first, the inside of a chamber is filled with a dry gas (first-stage gas replacement), and nebulizing of a matrix solution (first-stage nebulizing) is performed in a state where supply of the dry gas to the chamber is stopped or reduced. Thereafter, the inside of the chamber is filled with a dry gas again (second-stage gas replacement), and then the matrix solution is nebulized (second-stage nebulizing) while the supply of the dry gas to the chamber is continued. In this “second-stage nebulizing”, the supply of the dry gas is continued, whereby an increase in humidity associated with the nebulizing of the matrix solution is prevented. Therefore, the deposition amount of the matrix substance can be increased without increasing the crystal size. As a result, the ionization efficiency of the measurement target substance can be enhanced without reducing the spatial resolution in mass spectrometry imaging. In the “second-stage nebulizing”, the flow rate of the dry gas is set so as to prevent an increase in the humidity in the chamber with the progress of nebulizing of the matrix solution. Such a flow rate of the dry gas can be experimentally determined in advance, for example. Typically, the flow rate of the dry gas during the “second-stage nebulizing” is equal to the flow rate of the dry gas during the “second-stage gas replacement”.

It is preferable that the matrix film deposition system according to the present invention further includes a dry gas diffuser configured to diffuse a flow of the dry gas in the chamber.

According to such a configuration, it is possible to prevent a humidity gradient from being formed in the chamber by the dry gas and to prevent the nebulizing flow of the matrix solution from being disturbed by the flow of the dry gas even when the matrix solution is nebulized while supplying the dry gas to the chamber as in the second-stage nebulizing.

Further, a matrix film deposition method according to the present invention made to solve the above problems includes:

housing a sample plate in a chamber; filling the chamber with a dry gas by supplying the dry gas into the chamber; and then nebulizing a solution containing a matrix substance used for a matrix-assisted laser desorption/ionization method toward the sample plate in a state where the supply of the dry gas to the chamber is stopped or reduced.

The matrix film deposition method according to the present invention, may further include: stopping nebulizing of the solution containing the matrix substance; filling the chamber with the dry gas by supplying the dry gas to the chamber again; and then nebulizing the solution containing the matrix substance again toward the sample plate while continuing the supply of the dry gas to the chamber.

### Advantageous Effects of Invention

As described above, according to the matrix film deposition system and the matrix film deposition method according to the present invention, it is possible to stably achieve high spatial resolution and high detection sensitivity when mass spectrometry imaging is performed.

### BRIEF DESCRIPTION OF DRAWINGS

FIG. 1 is a schematic diagram showing a main configuration of a matrix film deposition system according to a first embodiment of the present invention.

FIG. 2 is a flowchart showing an example of an operation of a controller in the matrix film deposition system of the first embodiment.

FIG. 3 is a schematic view showing a trajectory of a central axis of a nebulizing flow on a sample plate.

FIG. 4 is a schematic diagram showing a main configuration of a matrix film deposition system according to a second embodiment of the present invention.

FIGS. 5A to 5C are views showing a configuration example of a diffusion plate according to the second embodiment, in which FIG. 5A shows a configuration having circular openings on the entire surface, FIG. 5B shows a configuration having circular openings in a partial region, and FIG. 5C shows a configuration having L-shaped linear openings.

FIGS. 6A and 6B are views showing a configuration example of a diffusion pipe according to the second embodiment, in which FIG. 6A is a perspective view of the diffusion pipe, and FIG. 6B is a perspective view showing a mounting position of the diffusion pipe in a chamber.

FIG. 7 is a flowchart showing an operation of a controller in the matrix film deposition system according to the second embodiment.

FIG. 8 is a schematic diagram showing a schematic configuration of a conventional spray-type matrix film deposition system.

### DESCRIPTION OF EMBODIMENTS

### First Embodiment

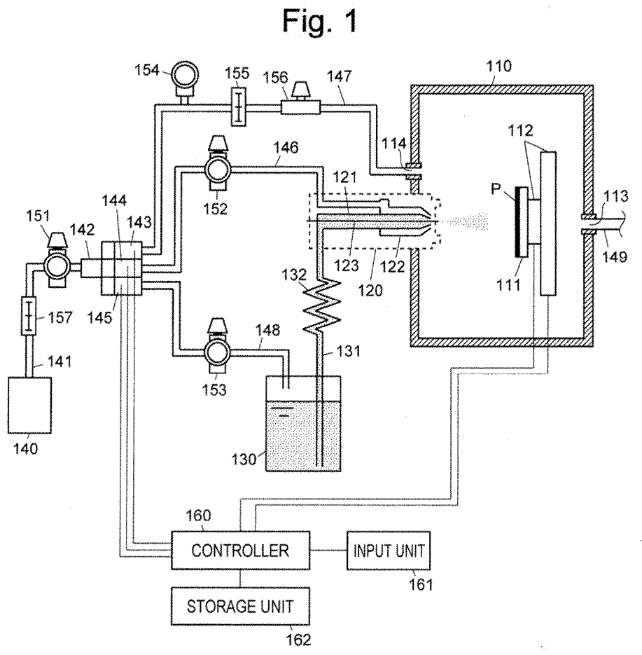

Hereinafter, a first embodiment of a matrix film deposition system according to the present invention will be described with reference to the drawings. FIG. 1 is a schematic diagram illustrating a main configuration of a matrix film deposition system according to the present embodiment. The matrix film deposition system according to the first embodiment has a chamber 110 in which a sample plate P is housed, and a nebulizing nozzle 120 for spraying a solution (matrix solution) containing a matrix substance to the sample plate P.

Inside the chamber 110, a sample stage 111 on which the sample plate P is placed and an XY stage 112 for moving the sample stage 111 are housed. On a wall surface of the chamber 110 facing the sample stage 111, a nebulizing nozzle 120 is attached, and a gas inlet 114 as a through hole is formed. It is preferable that both the nebulizing nozzle 120 and the gas inlet 114 are arranged near the center of the wall surface. This makes it possible to make the nebulizing flow and the replacement gas flow (dry gas flow) axially symmetrical in the up, down, left, and right directions, and to perform nebulizing and gas replacement uniformly and efficiently. On the other hand, a gas outlet 113 as a through hole is formed on a wall surface of the chamber 110 on the rear side of the sample stage 111. Further, a door (not shown) for inserting and removing the sample plate P is provided on the wall surface of the chamber 110 which is orthogonal to the wall surface to which the nebulizing nozzle 120 is attached. When the door is closed, the chamber 110 is sealed except for the gas inlet 114 and the gas outlet 113.

The nebulizing nozzle 120 has a double pipe structure including a solution pipe 121 and a gas pipe 122 which is coaxial with the solution pipe 121 and is disposed as an outer cylinder so as to surround the solution pipe 121. The solution pipe 121 has an inner diameter of about 0.3 mm at the tip portion, and a needle 123 for guiding the solution at the time of nebulizing is inserted into the center of the solution pipe 121. The tips of the solution pipe 121 and the gas pipe 122 are substantially at the same position in the length direction of the pipes 121 and 122, and the tip of the needle 123 slightly projects from the tip of the solution pipe 121.

One end of a solution supply pipe 131 is connected to the proximal end of the solution pipe 121, and the other end of the solution supply pipe 131 is disposed at the lower portion of a solution container 130 which is a sealed container housing the matrix solution (lower than the center of the solution container 130 in the height direction, preferably near the bottom surface). In addition, a resistance pipe 132 is inserted in an intermediate portion of the solution supply pipe 131. As the resistance pipe 132, a pipe having a sufficiently large resistance value compared to the resistance value at the tip of the solution pipe 121 of the nebulizing nozzle 120, for example, a capillary pipe having an inner diameter of 0.075 mm and a length of 20 mm is used. As the resistance pipe 132, a capillary made of silica, a capillary made of PEEK (polyetheretherketone) resin, or the like can be used. However, in view of durability, it is preferable to use a PEEK capillary.

One end of a nebulizing gas pipe 146 is connected to the proximal end of the gas pipe 122, and the other end of the nebulizing gas pipe 146 is connected to a gas source 140 via a manifold (multi-branch pipe) 142 and a common pipe 141. The gas source 140 includes, for example, a gas cylinder or a gas generator and has a constant and low humidity, and sends an inert gas having an absolute pressure higher than the atmospheric pressure to the common pipe 141. As such a gas source 140, it is preferable to use a liquefied nitrogen gas cylinder or a nitrogen gas generator. The manifold 142 has one inlet end and three outlet ends, the aforementioned common pipe 141 is connected to the inlet end, and the aforementioned nebulizing gas pipe 146 is connected to one of the three outlet ends. One of the remaining two outlet ends of the manifold 142 is connected to one end of a pressurizing gas pipe 148, and the other end of the pressurizing gas pipe 148 is disposed near the ceiling inside the solution container 130 (at least higher than the center of the solution container 130 in the height direction). One end of a replacement gas pipe 147 is connected to the remaining one outlet end of the manifold 142, and the other end of the replacement gas pipe 147 is connected to the gas inlet 114 of the chamber 110. An exhaust pipe 149 leading to a draft chamber (not shown) is connected to the gas outlet 113 provided in the chamber 110.

Solenoid valves are mounted on the three outlet ends of the manifold 142, respectively. Hereinafter, of these solenoid valves, the one provided at the outlet end to which the replacement gas pipe 147 is connected is referred to as a gas replacement valve 143, the one provided at the outlet end to which the nebulizing gas pipe 146 is connected is referred to as a nebulizing valve 144, and the one provided at the outlet end to which the pressurizing gas pipe 148 is connected is referred to as a pressurizing valve 145. In the present embodiment, the gas source 140, the common pipe 141, the manifold 142, the gas replacement valve 143, and the replacement gas pipe 147 correspond to the dry gas supplier in the present invention, and the nebulizing nozzle 120, the nebulizing valve 144, and the pressurizing valve 145 correspond to the nebulizer in the present invention.

The common pipe 141, the nebulizing gas pipe 146, and the pressurizing gas pipe 148 are provided with manual pressure regulating valves 151, 152, and 153, respectively. Further, the common pipe 141 is further provided with a flow meter 157, and the replacement gas pipe 147 is provided with a pressure gauge 154, a flow meter 155, and a manual flow regulating valve 156. Hereinafter, the gases flowing through the replacement gas pipe 147, the nebulizing gas pipe 146, and the pressurizing gas pipe 148 may be referred to as a replacement gas (corresponding to the dry gas in the present invention), a nebulizing gas, and a pressurizing gas, respectively.

Furthermore, the matrix film deposition system according to the present embodiment includes a controller 160 (corresponding to a controller in the present invention) for controlling the operations of the XY stage 112 and the solenoid valves 143, 144, and 145. The function of the controller 160 is realized by causing a computer having a CPU and a memory to execute a predetermined control program. An input unit 161 including a pointing device such as a mouse, a keyboard, and the like, and a storage unit 162 including a hard disk device or a flash memory are connected to the controller 160. The storage unit 162 stores the control program and stores various setting items input by the user using the input unit 161.

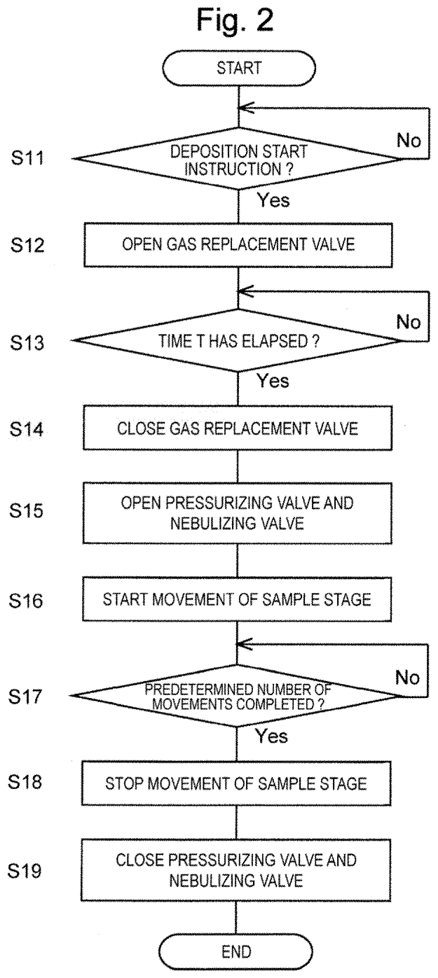

Hereinafter, a procedure for preparing (depositing) a sample using the matrix film deposition system according to the present embodiment will be described with reference to the flowchart of FIG. 2.

When deposition is performed by the matrix film deposition system according to the present embodiment, first, a worker (user) opens a door of the chamber 110 and places a sample plate P on which a sample such as a tissue slice is stuck on the sample stage 111. Subsequently, the user closes the door of the chamber 110, manually adjusts the opening degrees of the pressure regulating valves 151, 152, 153 and the opening degree of the flow regulating valve 156 as necessary, and then operates the input unit 161 to input an instruction to start deposition. In the present embodiment, the pressure regulating valves 151, 152, 153 and the flow regulating valve 156 are manually operated. However, these may be assumed to be driven by a motor, and the controller 160 may be configured to regulate the opening degrees of the pressure regulating valves 151, 152, 153 and the flow regulating valve 156 based on a set value input in advance by the user via the input unit 161.

When an instruction to start deposition is input from the input unit 161 (Yes in step S11), the controller 160 first sends a control signal to the gas replacement valve 143 to open the valve 143 (step S12). As a result, the inert gas supplied from the gas source 140 flows through the manifold 142 and the replacement gas pipe 147 to the inside of the chamber 110. As the replacement gas is thus introduced to the inside of the chamber 110, the air existing in the chamber 110 is discharged from the gas outlet 113.

Thereafter, when a predetermined time T has elapsed (Yes in step S13), the controller 160 sends a control signal to the gas replacement valve 143 to close the valve 143 (step S14). As for the time T, a time sufficient for completely replacing the air in the chamber 110 with the inert gas (replacement gas) is determined by the user in advance based on the volume of the chamber 110, the flow rate of the replacement gas, and the like, and is stored in the storage unit 162.

Here, the gas replacement valve 143 is closed when a predetermined time T has elapsed since the gas replacement valve 143 was opened. Instead of this, the gas replacement valve 143 may be closed, for example, when the user instructs to start nebulizing the matrix solution (that is, when the nebulizing start instruction is input from the input unit 161 to the controller 160). Further, the gas replacement valve 143 may be closed when a predetermined amount of the replacement gas is supplied to the chamber 110 after the gas replacement is started. In this case, for example, a configuration in which the measurement result by the flow meter 155 or the flow meter 157 is input to the controller 160, and the controller 160 calculates the supply amount of the replacement gas from the gas replacement start time based on the input is adopted. In step S14, instead of closing the gas replacement valve 143 (that is, completely stopping the supply of the replacement gas), the flow rate of the replacement gas may be reduced by adjusting the flow regulating valve 156 while keeping the gas replacement valve 143 in the open state.

Subsequently, the controller 160 sends a control signal to the nebulizing valve 144 and the pressurizing valve 145 to open these valves 144 and 145 (step S15). At this time, by opening the nebulizing valve 144, the inert gas supplied from the gas source 140 to the manifold 142 further flows also into the nebulizing gas pipe 146. Further, by opening the pressurizing valve 145, the inert gas supplied from the gas source 140 to the manifold 142 flows also into the pressurizing gas pipe 148. As a result, the inert gas (pressurizing gas) is introduced into the upper space of the solution container 130 from the tip of the pressurizing gas pipe 148, and the liquid surface of the matrix solution in the solution container 130 is pressurized by the pressurizing gas. As a result, the matrix solution is introduced into the solution supply pipe 131 and is discharged from the solution pipe 121 of the nebulizing nozzle 120 via the resistance pipe 132.

In step S15, either the pressurizing valve 145 or the nebulizing valve 144 may be opened first, or both may be opened simultaneously. In addition, here, the pressurizing valve and the nebulizing valve are opened in step S15 after the gas replacement valve 143 is closed in step S14, but steps S14 and S15 may be performed in the reverse order. That is, for example, when a predetermined time T has elapsed after the gas replacement valve 143 is opened in step S12, the pressurizing valve 145 and the nebulizing valve 144 may be first opened, and the gas replacement valve 143 may be closed immediately thereafter. Alternatively, steps S14 and S15 may be performed simultaneously.

As described above, the inert gas (nebulizing gas) is ejected from the tip of the gas pipe 122 of the nebulizing nozzle 120, and the matrix solution flowing out of the tip of the solution pipe 121 is sheared by the nebulizing gas to become fine droplets, and the droplets are ejected from the nebulizing nozzle 120 together with the nebulizing gas.

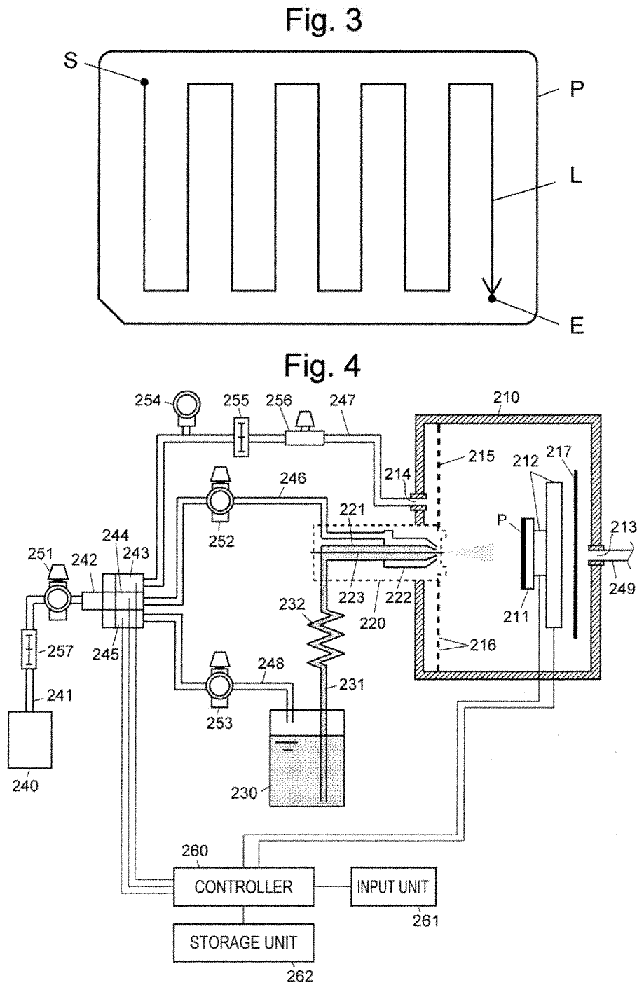

When the nebulizing of the matrix solution is started, the controller 160 sends a control signal to the XY stage 112 to start the movement of the sample stage 111 (step S16). The XY stage 112 having received the control signal moves the sample stage 111 so that the matrix solution is nebulized uniformly on the entire surface of the sample plate P. The trajectory L of the center axis of the nebulizing flow (that is, the flow of the matrix solution nebulized from the nebulizing nozzle 120) on the sample plate P at this time is schematically shown in FIG. 3. As illustrated in the drawing, the XY stage 112 moves the sample stage 111 in a zigzag manner such that the central axis of the nebulizing flow draws a zigzag-shaped trajectory L on the sample plate P. When the central axis of the nebulizing flow reaches the end point E from the start point S of the trajectory L, the controller 160 controls the XY stage 112 to return the central axis to the start point S of the trajectory L again. Thereafter, the controller 160 controls the XY stage 112 so that the central axis moves again in a zigzag manner from the start point S to the end point E of the trajectory L.

Assuming that the movement of the central axis of the nebulizing flow from the start point S to the end point E of the zigzag-shaped trajectory L as described above is one time movement, when the XY stage 112 is moved a predetermined number of times (that is, Yes in step S17), the controller 160 stops the movement of the sample stage 111 by the XY stage 112 (step S18). Furthermore, the controller 160 closes the nebulizing valve 144 and the pressurizing valve 145 to stop nebulizing the matrix solution to the sample plate P (step S19). Here, the movement of the sample stage 111 and the nebulizing of the matrix solution are stopped when the movement of the sample stage 111 is performed a predetermined number of times, but the present invention is not limited thereto, and the movement of the sample stage 111 and the nebulizing of the matrix solution may be stopped at a timing when a predetermined time has elapsed from the time when the nebulizing is started (that is, the time when both the nebulizing valve 144 and the pressurizing valve 145 are opened).

As described above, when the deposition of the matrix film to the sample plate P is completed, the user opens the door of the chamber 110 and takes out the sample plate P. Thereafter, when deposition is performed continuously to another sample plate P, a new sample plate P is set on the sample stage 111, and the above operation is repeatedly performed.

As described above, in the matrix film deposition system according to the present embodiment, the air in the chamber 110 is replaced with the inert gas supplied from the gas source 140, and then the matrix solution is nebulized. Therefore, there is no variation in the size of the crystal particles formed on the sample plate P due to the humidity of the outside air as in the conventional case, and it is possible to always perform mass spectrometry imaging with stable spatial resolution. In addition, since a low-humidity gas (dry gas) is used as the inert gas, the size of crystal particles formed on the sample plate can be suppressed as compared with a case where such gas replacement is not performed, and high resolution can be achieved in mass spectrometry imaging. In addition, in the matrix film deposition system according to the present embodiment, since the matrix solution is nebulized after the introduction of the dry gas as described above is stopped or reduced, the humidity in the chamber 110 increases with the progress of nebulizing. Therefore, as compared with a case where nebulizing is performed while the introduction of the dry gas is continued at the same flow rate as that at the time of performing the gas replacement, the extraction efficiency of the sample component by the matrix solution nebulized on the sample plate P can be enhanced, and the detection sensitivity of the measurement target substance in mass spectrometry imaging can be enhanced.

### Second Embodiment

Next, a second embodiment of a matrix film deposition system according to the present invention will be described. In the matrix film deposition system according to the present embodiment, similarly to the first embodiment, after the inside of the chamber is replaced with a dry gas, the matrix solution is nebulized (first-stage nebulizing) in a state where the introduction of the dry gas is stopped, and after the inside of the chamber is replaced again with the dry gas, the matrix solution is nebulized (second-stage nebulizing) while the introduction of the dry gas is continued.

FIG. 4 shows a main configuration of the matrix film deposition system according to the present embodiment. In the drawing, the same or corresponding components as those illustrated in FIG. 1 are denoted by the same reference numerals in the last two digits, and the description thereof is appropriately omitted. This matrix film deposition system includes, in addition to the configuration similar to that of the matrix film deposition system according to the first embodiment, inside a chamber 210, two replacement gas diffusers which are a diffusion plate 215 for diffusing the replacement gas introduced from a gas inlet 214, and a bypass plate 217 for diffusing a gas (air or replacement gas) flow by detouring the gas flow toward a gas outlet 213. These are for preventing a humidity gradient from being formed in the chamber by the introduction of an inert gas or a nebulizing flow of the matrix solution from being disturbed by the inert gas during the second-stage nebulizing.

The diffusion plate 215 is a plate having a plurality of openings 216 formed therein, and for example, a punching metal or the like can be used. In the matrix film deposition system shown in FIG. 4, the internal space of the chamber 210 is divided into two by the diffusion plate 215, and the replacement gas introduced into one space from the gas inlet 214 passes through any of the plurality of openings 216 provided on the diffusion plate 215 and flows into the other space (the space where a sample stage 211 is disposed). On the other hand, the bypass plate 217 is a plate whose area is larger than the opening area of the gas outlet 213 and smaller than the cross-sectional area of the chamber 210 in a plane orthogonal to the central axis of the nebulizing flow, and is disposed in front of the gas outlet 213 in a state of being in parallel with the wall surface on which the gas outlet 213 is provided and being separated from the wall surface by several centimeters.

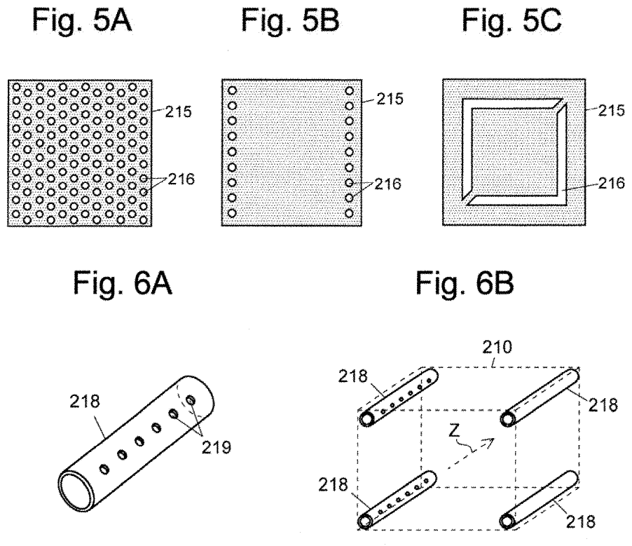

As the diffusion plate 215, for example, a plate having the openings 216 on the entire surface as shown in FIG. 5A may be used, or a plate having the openings 216 only in a partial region (for example, at peripheral edge portions) as shown in FIG. 5B may be used. As the size (opening area) of the opening 216 increases, the speed of replacing the gas in the chamber 210 increases, but the effect of diffusing the flow of the replacement gas decreases. On the other hand, as the opening 216 is smaller, the effect of diffusing the flow of the replacement gas is improved, but the speed of replacing the gas in the chamber 210 becomes slower. Therefore, the size of the opening 216 may be appropriately determined based on a desired gas replacement speed and uniformity of the matrix crystal. However, in order to surely diffuse the flow of the replacement gas, the size of each opening 216 is preferably made smaller than the size of the opening at the outlet portion of the gas inlet 214 for the replacement gas. In addition, the shape of the opening 216 is not limited to a circle, but may be a polygon, a line, or the like, and for example, as shown in FIG. 5C, may be a shape obtained by cutting a partial region of the diffusion plate 215 into an L-shaped linear shape.

Further, instead of the diffusion plate 215 as described above, a pipe having a plurality of openings 219 on a peripheral surface (hereinafter, referred to as a diffusion pipe 218) as shown in FIG. 6A may be disposed in the chamber 210. As shown in FIG. 6B, it is preferable to arrange the diffusion pipe(s) 218 along one or a plurality of sides (four sides in FIG. 6B) parallel to the central axis Z of a nebulizing nozzle 220 among the respective sides of a rectangular parallelepiped space in the chamber 210. The distal end side of each of these diffusion pipes 218 is closed, and the proximal end side thereof is connected to the gas inlet 214.

As described above, the replacement gas diffuser in the present invention can take various forms as long as it has a function of diffusing the flow of the replacement gas introduced into the chamber 210. However, if the diffusion plate 215 is a flat plate having openings 216 as shown in FIGS. 5A to 5C, since the replacement gas diffuser can be formed only by forming openings 216 in a metal plate by a punching press or the like and then mounting the metal plate in the chamber 210, production of the diffusion plate 215 becomes easier. Furthermore, in addition to such easiness of production, by forming a plate shape having openings 216 on the entire surface as shown in FIG. 5A, it is possible to further improve the uniformity of the replacement gas in the chamber 210.

However, in order to reduce disturbance of the nebulizing flow due to the replacement gas, it is preferable that the ejection linear velocity of the replacement gas in the chamber 210 be sufficiently lower than the ejection linear velocity of the nebulizing gas. This can be realized, for example, by making the opening area of the gas inlet 214 sufficiently larger than the opening area of a gas pipe 222. In addition, a pressure adjustment valve 252 for the nebulizing gas and a flow regulating valve 256 for the replacement gas adjust the flow rate of the replacement gas to be larger than the flow rate of the nebulizing gas at the time of performing nebulizing. This makes it possible to increase the replacement speed of the gas in the chamber 210 and suppress a change in humidity in the chamber 210 due to the nebulizing of the matrix solution.

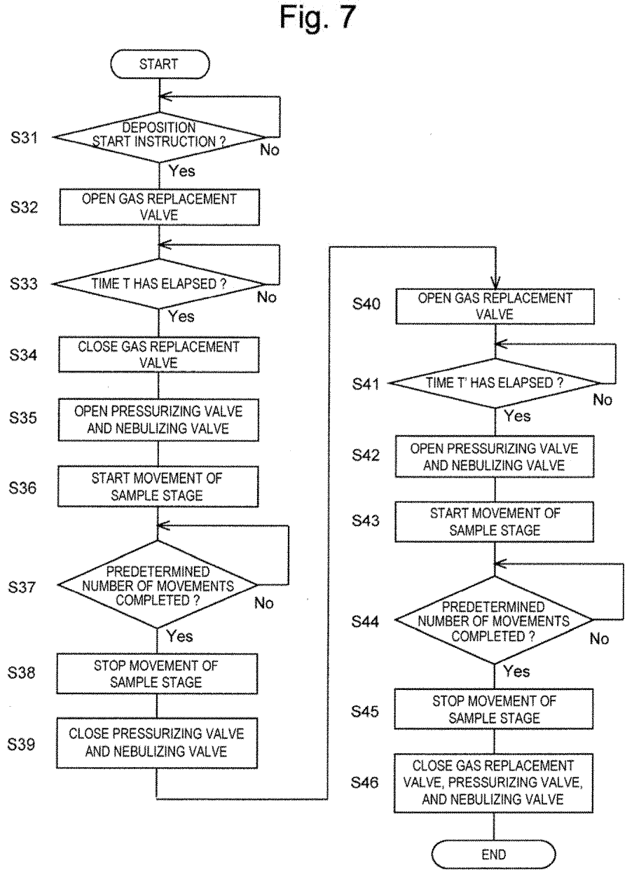

Hereinafter, a procedure for preparing a sample using the matrix film deposition system according to the present embodiment will be described with reference to the flowchart of FIG. 7. The operation from when the user inputs a deposition start instruction to when the first-stage nebulizing is completed (that is, steps S31 to S39 in FIG. 7) is similar to steps S11 to S19 in FIG. 2, and thus the description thereof is omitted.

When the first-stage nebulizing is completed, a controller 260 opens the gas replacement valve 243 (step S40) and starts introducing the replacement gas into the chamber 210 again.

Thereafter, when a predetermined time T′ has elapsed (Yes in step S41), the controller 260 opens the pressurizing valve 245 and the nebulizing valve 244 to start nebulizing the matrix solution (nebulizing in the second stage) (step S42). Furthermore, a controller 260 sends a control signal to an XY stage 212 to start the movement of the sample stage 211 (step S43).

The above-described time T′ is a time sufficient for completely replacing the gas in the chamber 210 with the inert gas (replacement gas), and is typically the same time as the execution time of the gas replacement performed before the start of the first-stage nebulizing (that is, the time T in step S33), but is not necessarily limited thereto.

In addition, here, the second-stage nebulizing is started when the predetermined time T′ elapses after the gas replacement valve 243 is opened, but instead of this, for example, the second-stage nebulizing may be started when the user instructs to start nebulizing the matrix solution (that is, when the nebulizing start instruction is input from the input unit 261 to the controller 260). Further, the second-stage nebulizing may be started when a predetermined amount of the replacement gas is supplied to the chamber 210 after the gas replacement is started.

The gas replacement valve 243 is kept open and the replacement gas is continuously introduced from the gas inlet 214 while the matrix solution is nebulized (second-stage nebulizing) to the sample plate P as described above. In the system according to the present embodiment, as described above, the space in the chamber 210 is partitioned into two by the diffusion plate 215, and the replacement gas introduced into the chamber 210 flows into one of the spaces partitioned by the diffusion plate 215. Then, the inert gas is diffused by passing through the opening 216 formed in the diffusion plate 215, and flows into the other space (the space where the sample plate P is disposed) in the chamber 210 at a low flow rate. The inert gas that has flowed into the space where the sample plate P is disposed is further diffused by colliding with and bypassing the bypass plate 217 disposed in front of the gas outlet 213, and is then discharged from the gas outlet 213. Therefore, it is possible to prevent a humidity gradient from being formed in the chamber 210 by the replacement gas introduced into the chamber 210 or to prevent the nebulizing flow of the matrix solution from being disturbed by the replacement gas during the second-stage nebulizing.

Also during the second-stage nebulizing, the XY stage 212 moves the sample stage 211 such that the central axis of the nebulizing flow relatively moves in a zigzag manner with respect to the sample plate P as illustrated in FIG. 3.

When the movement of the XY stage 212 is performed a predetermined number of times (that is, Yes in step S44), the controller 260 stops the movement of the sample stage 211 by the XY stage 212 (step S45). Furthermore, the controller 260 closes the nebulizing valve 244 and the pressurizing valve 245 to stop nebulizing the matrix solution to the sample plate P, and closes the replacement gas valve 243 to stop introduction of the replacement gas into the chamber 210 (step S46). Here, the movement of the sample stage 211 and the nebulizing of the matrix solution are stopped when the movement of the sample stage 211 is performed a predetermined number of times, but the present invention is not limited thereto, and the movement of the sample stage 211 and the nebulizing of the matrix solution may be stopped when a predetermined time has elapsed from the time when the nebulizing is started (that is, when both the nebulizing valve 244 and the pressurizing valve 245 are opened).

The “predetermined number of times” (that is, the number of times of overlapping nebulizing of the matrix solution to the sample plate P in the first-stage nebulizing) in step S37 is preferably as many times as possible within a range in which the crystal particles formed on the sample plate P do not become too large. In addition, the “predetermined number of times” (that is, the number of times of overlapping nebulizing of the matrix solution to the sample plate P in the second-stage nebulizing) in step S44 is preferably the number of times obtained by subtracting the number of times of overlapping nebulization in the first-stage nebulization from the number of times of overlapping nebulization of the matrix solution to the sample plate P necessary for achieving sufficient ionization efficiency. These numbers of times can be experimentally determined in advance.

As described above, when the deposition of the matrix film on the sample plate P is completed, the user opens the door of the chamber 210 and takes out the sample plate P. Thereafter, when deposition is performed continuously on another sample plate P, a new sample plate P is set on the sample stage 211, and the above operation is repeatedly performed.

As described above, in the matrix film deposition system according to the present embodiment, in the second-stage nebulizing, the matrix solution is nebulized while the replacement gas is introduced into the chamber 210, whereby an increase in humidity in the chamber 210 during the execution of the nebulizing is prevented. Therefore, the amount of the matrix substance applied to the sample plate P can be increased without increasing the crystal size. As a result, the ionization efficiency of the measurement target substance can be enhanced without reducing the spatial resolution in mass spectrometry imaging.

As described above, the embodiments for carrying out the present invention have been described. However, the present invention is not limited to the above-described embodiments, and may be appropriately changed within the scope of the present invention.

For example, in the above embodiment, the matrix film deposition system according to the present invention performs the nebulizing of the matrix solution by the spray method. However, the present invention is not limited to this, and is also applicable to a device for nebulizing a matrix solution (see Patent Literature 1) by the electrospray deposition (ESD) method.

In the above-described first and second embodiments, the sample plate P is moved by the XY stage 112, 212. Alternatively, the nebulizing nozzle 120, 220 may be moved in a plane parallel to the sample plate P.

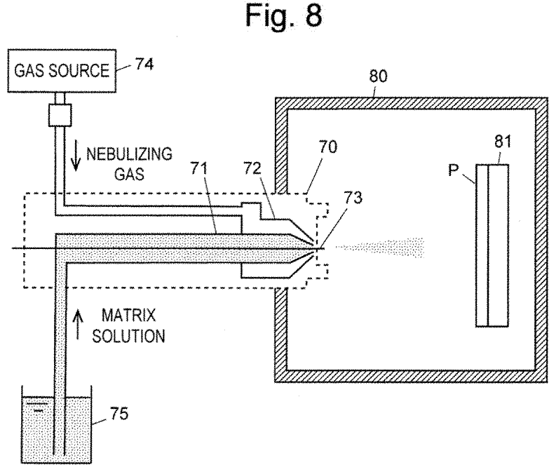

Furthermore, in the above-described first and second embodiments, the matrix solution is delivered by pressurizing the liquid surface of the matrix solution in the solution container 130, 230 with the gas supplied from the gas source 140, 240. However, the matrix solution may be pressurized and delivered by another method, for example, a syringe pump. In addition, a configuration in which the matrix solution is not pressurized or delivered, but the matrix solution in a solution container 75 is sucked into a solution pipe 71 of a nebulizing nozzle 70 by the Venturi effect, as in the conventional matrix film deposition system shown in FIG. 8 may be adopted.

### REFERENCE SIGNS LIST

110, 210 . . . Chamber
111, 211 . . . Sample Stage
112, 212 . . . XY Stage
113, 213 . . . Gas Outlet
114, 214 . . . Gas Inlet
215 . . . Diffusion Plate
216 . . . Opening
217 . . . Bypass Plate
218 . . . Diffusion Pipe
219 . . . Opening
120, 220 . . . Nebulizing Nozzle
130, 230 . . . Solution Container
131, 231 . . . Solution Supply Pipe
132, 232 . . . Resistance Pipe
140, 240 . . . Gas Source
141, 241 . . . Common Pipe
142, 242 . . . Manifold
143, 243 . . . Gas Replacement Valve
144, 244 . . . Nebulizing Valve
145, 245 . . . Pressurizing Valve
146, 246 . . . Nebulizing Gas Pipe
147, 247 . . . Replacement Gas Pipe
148, 248 . . . Pressurizing Gas Pipe
149, 249 . . . Exhaust Pipe
160, 260 . . . Controller
161, 261 . . . Input Unit
162, 262 . . . Storage Unit
P . . . Sample Plate

1. A matrix film deposition system, comprising:
a chamber configured to house a sample stage on which a sample plate is placed;
a nebulizer arranged to nebulize a solution containing a matrix substance used for a matrix-assisted laser desorption/ionization method toward the sample stage;
a gas inlet formed in the chamber;
a dry gas supplier arranged to supply a dry gas through the gas inlet; and
a controller configured to control the dry gas supplier and the nebulizer to supply the dry gas through the gas inlet to fill the chamber with the dry gas, and then to nebulize the solution containing the matrix substance in a state where supply of the dry gas through the gas inlet is stopped or reduced.

2. The matrix film deposition system according to claim 1, wherein the controller further controls the dry gas supplier and the nebulizer so as to stop nebulizing of the solution containing the matrix substance by the nebulizer, fill the chamber with the dry gas by supplying the dry gas through the gas inlet again, and then perform nebulizing of the solution containing the matrix substance by the nebulizer again while continuing supply of the dry gas through the gas inlet.

3. The matrix film deposition system according to claim 2, further comprising
a dry gas diffuser configured to diffuse a flow of the dry gas in the chamber.

4. A matrix film deposition method, comprising:
housing a sample plate in a chamber;
filling the chamber with a dry gas by supplying the dry gas into the chamber; and then
nebulizing a solution containing a matrix substance used for a matrix-assisted laser desorption/ionization method toward the sample plate in a state where the supply of the dry gas to the chamber is stopped or reduced.

5. The matrix film deposition method according to claim 4, further comprising:
stopping nebulizing of the solution containing the matrix substance;
filling the chamber with the dry gas by supplying the dry gas to the chamber again; and then
nebulizing the solution containing the matrix substance again toward the sample plate while continuing the supply of the dry gas to the chamber.
